(19) United States
(12) Patent Application Publication
(10) Pub. No.: US 2006/0173890 A1
(43) Pub. Date: Aug. 3, 2006

(54) Method and data carrier for handling a database

(76) Inventors: Uwe Janssen, Seelze (DE); Meinolf Blawat, Hannover (DE); Hui Li, Hannover (DE); Ralf Ostermann, Hannover (DE); Marco Winter, Hannover (DE)

Correspondence Address: THOMSON LICENSING INC., PATENT OPERATIONS, PO BOX 5312, PRINCETON, NJ, 08543-5312, US

(21) Appl. No.: 10/564,399

(22) PCT Filed: Jul. 16, 2004
(86) PCT No.: PCT/EP04/07985

§ 371 Date: Jan. 12, 2006

(30) Foreign Application Priority Data
Jul. 19, 2003 (DE) 03016382.8

(51) Int. Cl. G06F 17/00

(52) U.S. Cl. 707/102

(57) ABSTRACT

In the field of data storage on limited rewritability storage media, handling frequently changing databases may lead to unequal wear of storage segments. The invention discloses a method for modifying a database file, which ensures maximally distributed segment wear in that any writing of data records uses a next available segment after the last written segment; and a reading method. A data carrier according to the method, containing a database file with records having version numbers is also disclosed.

The invention relates to the field of optical recording, more specifically to the maintenance of databases containing metadata under the restrictions imposed by optical recording media.

### BACKGROUND

Metadata is a term known in the art denoting data about data. Metadata being structured, they can be stored in databases. In future multimedia applications, metadata will likely be large in size and frequently changing; they will likely be stored on rewritable optical data carriers, alongside the data they relate to. Storage of frequently changing, “living” databases on rewritable optical media is hampered by the fact that such media allow only a limited number of rewrite cycles for each data sector. Too many write cycles for a data sector lead to a degradation of the sector. Hence a problem arises to devise a database management system adapted to the context of a limited rewrite cycle environment.

### INVENTION

The mentioned problem, and others, are solved in the invention by a method for modifying a database file containing the steps of: reserving, within the database file, at least one area of predetermined size and position dedicated to writing thereto data records of at least one type, respectively; indicating within the database file, as a last written segment, that segment within the area to which data records were last written; and ensuring distributed write in that, whenever a data record of a specific type is to be written to the database, the writing uses, within the area dedicated to the specific type, the next available segments after the last written segment.

In this, advantageously, the segments are first written in sequential order into a database area. After that, when the last segment of a database area has been written, the next write operation will wrap around to the beginning of the database area again, and will write to any unused or invalidated segments found there. Active segments, i.e. segments containing valid data, will not be changed or overwritten. They can only be invalidated. Changed content can only be written to one of the next segments ready for writing to. So, even in a second or consecutive pass through the database area, sequential writing is maintained as much as possible, hence ensuring distributed write as much as possible.

According to another aspect of the invention, modifying a data record of a specific type in the database file contains the steps of: reading, from the associated database area, the data record; modifying the read data record; obtaining a first write address information indicating a segment within the area to which a data record of the specific type was last written; forwarding, as part of ensuring distributed write, the first write address information so that it indicates a next segment within the area which contains unused space; and writing the modified data record to the segment as indicated by the first write address information.

Databases may contain a control area comprising several control blocks. Typically, only one of these control blocks of one or more contiguous segments will be valid. Such control block typically is subject of frequent changes and may contain information about the validity of documents and segments in a payload area as well as of indices in an index area in the database. At least prior to ejecting a data carrier when the database content has changed, the new control block has to be written and shall be written to the next segments in the control area. This spreads the number of write or rewrite operations for the control block to all the segments in the control area. When opening an unknown data carrier, the one and only valid control block has to be found by inspecting an attached version number, as there is no possibility to store its permanently changing segment address at a fixed position on the data carrier.

According to this aspect of the invention, deleting a payload data record from a database file containing a control area, contains the steps of: reading, from the control area, control blocks containing information associated to the payload data record to be deleted; marking, in the read control blocks, the payload data record to be deleted as deleted, thereby obtaining a modified control block; obtaining a write address information indicating the segment within the control area to which a control block was last written; forwarding, as part of ensuring distributed write, the write address information so that it indicates a next segment within the control area which contains unused space; and writing the modified control block to the segment as indicated by the forwarded write address information.

According to another aspect of the invention, ensuring distributed write contains substeps of incrementing the write address information until it indicates a next segment after the last written segment which contains unused space; and resetting the write address information to the start of the area in case the incrementing has caused the write address information to indicate a segment beyond the end of the area. This contributes to maintaining sequential writing as much as possible, even in a second or consecutive pass through the database area, hence ensuring distributed write as much as possible. Also, the bigger an area has been dimensioned at database creation time, the less often will this “wrap-around” happen; hence, under an otherwise unchanged application, there is an inverse relationship between the size of an area and the average number of rewrites of the segments within that area.

The invention relates to a general database format as well as to a data carrier write strategy, which advantageously ensure a number of rewrite operations for each data sector to be leveled as much as possible. In this way degradation of specific sectors of the data carrier is avoided. The system of this invention is distinguished by being adapted to specific characteristics of optical data carriers like a limited number of rewrite cycles and a relatively high track seek time in comparison to hard disks. For some media, about 1000 rewrite cycles are realistic to assume, which is a high number considering the rewrite strategy in use and will not be reached in normal use cases.

### DRAWINGS

Exemplary embodiments of the invention are illustrated in the drawings and are explained in more detail in the following description.

In the figures:

FIG. 1 shows an example illustrating the area concept according to the invention;

FIG. 2 shows a timing diagram of several concurrent search operations accessing a single database and being managed according to the invention;

FIG. 3 shows the low-level segmentation of a database file according to the invention;

FIG. 4 shows a database file with the database header emphasized;

FIG. 5 shows a control area within a database file according to the invention, and its structure;

FIG. 6 shows an index area within a database file according to the invention, and its structure;

FIG. 7 shows a payload area within a database file according to the invention, and its structure;

FIG. 8 shows segment content illustrating a document write strategy according to the invention;

FIG. 9 shows segment content illustrating a document edit and delete strategy according to the invention;

FIG. 10 shows qualitatively segment content illustrating a payload segment write strategy according to the invention.

### EXEMPLARY EMBODIMENTS

An embodiment of the invention uses a pre-allocated contiguous area of the available storage space for the database. This can be a simple file or a partition depending on the file system of the data carrier. The only requirement is for it to be organized in segments and to have random read and write access.

Except a first segment containing static database information like sizes of all areas and segment size and version, all other segments of the DBFile are grouped into several distinct database areas like control area, index area, payload area. The sizes of each area are application specific and specified at DBFile creation time. Each area of the DBFile advantageously can be organized in segments of constant size, which should reasonably be a multiple of the ECC-block size. The Error Correction Code or ECC determines the smallest readable block on data carrier. Hence it is also advantageous to align the segment borders with ECC-block borders. Applications may exist, where it is advantageous to use a different although constant segment size within each area, respectively.

Payload data, also denoted as documents or records, will be stored in the payload area. A segment in this area can store one or more documents. Documents may span over one or more segments due to their size or due to using the last free space in an almost full segment. Only complete documents are added, retrieved, or invalidated/“removed”. “Removed” documents will not really be removed on the data carrier because of the additional write access to the segment this would cause. Rather, they will just be invalidated in the control block. Any unused parts in segments can be left unused until e.g. the number of completely unused segments gets low. Then the remaining documents in partially invalidated segments can advantageously be gathered and put into new segments, as a kind of garbage collection. In this way the old segments will become available for new documents.

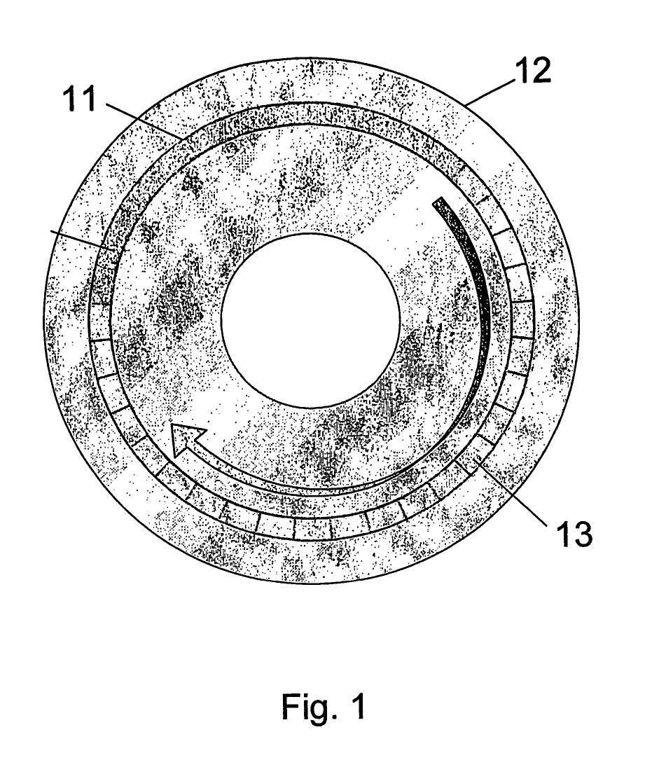

FIG. 1 shows, that for a write strategy of this kind, the database according to this invention is divided into different areas 11 on a storage space 12, which are continuously written and only rewritten if all sectors of the area have been written, too. Even if meanwhile some sectors have been marked as unused, they are not reused immediately, but only after all other unused sectors 13 of the area 11 have been used. After a wrap around, all free sectors are treated in the same way as above. In this way, a nearly equal and low number of rewrite cycles per sector can be achieved.

It must be noted, that the system of this invention, despite being adapted to the specific characteristics of optical data carriers, can nevertheless also be used on hard disk storage without drawback.

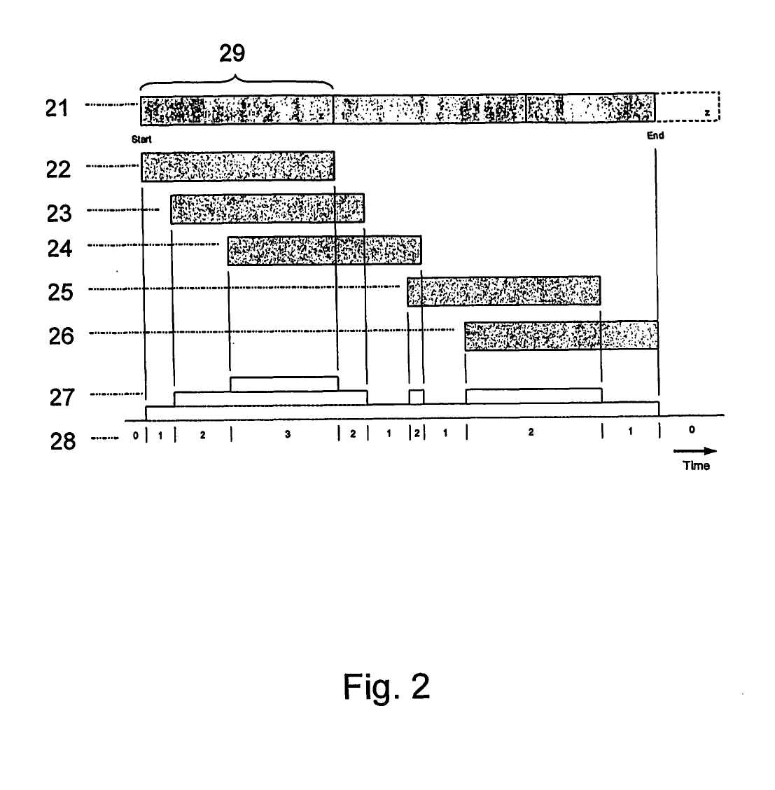

FIG. 2 shows a way to execute parallel search operations. As long as any search operations 22,23,24,25,26 are active, a single search process 21 is running which permanently and cyclically reads 29 all documents 1, . . . , z in the database in their physical order and which in turn calls the search processors of all active search operations once for each document. Each new search operation that starts the search process or that joins an already running search process memorizes the location of the first document it gets and terminates its activity only after the same or a following document has been reached again after one wrap around. The search process 21 terminates when the number 27, 28 of active search operations is back to 0, i.e. when no more active search operation exists. With this method the number of data carrier accesses for servicing all search operations is minimized, and, additionally, due to traversing the documents in physical order, jump times involved between consecutive document read operations are minimized, too.

In summary, search operations are optimized with respect to the physical order of the payload within the database file. Even the parallel execution of multiple search operations is possible. This enables multi-user applications. The underlying file structure ensures the best performance for optical recording media with respect to a very limited and nearly equal number of rewrite cycles for all sectors.

Error-Correction-Code Blocks, are the smallest segments readable and writable on optical data carriers. The database file is advantageously designed to occupy one area consisting of one continuous extent of these ECC blocks, organized as one file under the pertinent file system. No other file is needed on the data carrier. The internals of this database file are managed by the system of the invention, there is no reliance on specific file system features to support the rewrite strategy of this invention. With this design, the fragmentation of stored data can be determined and controlled. The size of the database file can be set to a default value and may be adjusted if necessary. The database file should be big enough to avoid the need for any sophisticated operations, otherwise a complete database reorganization may be necessary in the worst case. On the other hand, in situations when other applications need more space on the data carrier outside the database file, there also is the option to reduce the size of the database.

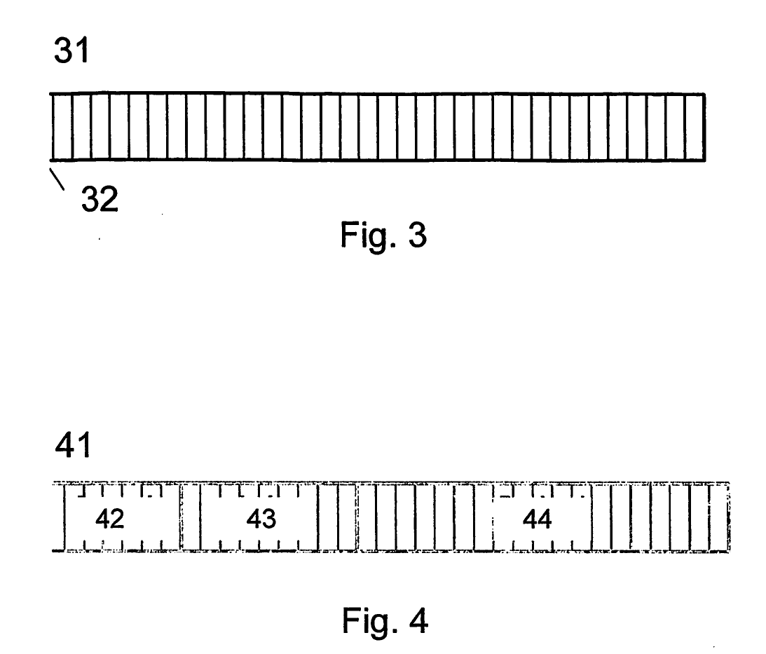

FIG. 3 shows that on its lowest level, the database file 31 is segmented into segments 32 of constant size. The segment size advantageously is an integer multiple of the ECC block size. Segment size has to be defined at database file creation time and cannot be changed during database lifetime. The only way to change the segment size would be to perform a complete transfer of all documents from the current database file into a new, appropriately dimensioned database file.

Due to the limited number of rewrite cycles of the data carrier, there is the rule that segments cannot be changed. With other words, segments will never be read, modified, and then stored back to the same location on the data carrier. Rather, segments can only be invalidated completely or in parts. Changed content has to be invalidated at its original location and then has to be written to the next segment ready for writing to, which normally is a different location. While adding documents to the database file, segments can be write-cached until their capacity is completely used.

FIG. 4 shows segments grouped into areas 41, 42, 43, 44 of consecutive segments. One of these areas consists of only one segment and is used for a database header 41 containing static information of the database that does not change during the database lifetime. The segments in the subsequent areas 42, 43, 44 are used in circular order according to their position in the database file to achieve a nearly equal number of rewrite cycles for the segments within each area. The Database Header may contain information like:

A start code for easy identification of the database file

A version number

Segment size

Control area size

Index area size

Payload area size.

The Header segment 41 is normally written only once in the lifetime of a database file. It has only to be changed if the database is reorganized in such a way as to change one of the Database Header fields, e.g. changing the size of segments, the size of areas or the internal data format. This may happen upon an update of related specifications.

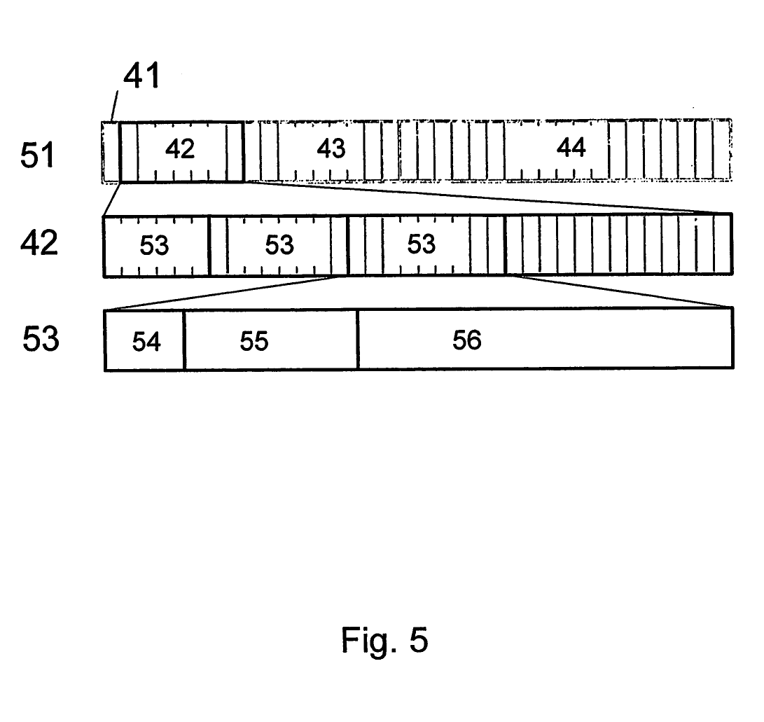

In certain cases, it is advantageous to employ control blocks in a separate control area 42, as shown in FIG. 5. Consider the situation where a segment for database payload contains several documents, and one of these documents has to be deleted. Due to the rule that segments cannot be changed, there are two approaches to manage this delete operation. Either the content of the complete segment must be read, modified, and then rewritten to the next segment ready for writing to, or some kind of control data has to be employed, and has to be kept separate from the payload data. Control Data can then mark the deleted document as invalid data in the original segment. The first approach may lead to a less fragmented database but in cases where e.g. the last document in the segment spans more than one segment, all these segments would have to be read, modified, and rewritten in the same way as the first segment. Therefore the second approach is advantageously employed, which improves the performance of the database. As the needed control data may be changed several times before the complete segment will be invalidated, control data is stored into the control area 42. The control area comprises one or more control blocks 53 and is adapted to the frequent changes.

The control block 53 is the container for the possibly changing information about segments containing payload or indexes. Control block data will typically be loaded into memory when the database is opened and can be kept in memory until the database is closed. The control block needs only to be written back to data carrier if it has been changed. For security reasons the changed control block may be stored more than once on the data carrier to improve resilience against data loss in case of system failure. The following information about the database can be stored in the control block:
A header 54;
References to segments that have been last written in the Index and payload areas;
Validity flags for payload and index segments;
Index control data 55 like information about available and valid indices;
Payload control data 56 like validity flags for documents in payload segments, or information about split documents like flags indicating the first part or the number of parts.

FIG. 5 also shows that, to avoid writing the control block 53 to the same location of the data carrier, every new version of the control block will be written to one or more different segments in the control area 42. As an implicit rule, only the control block written last is to be considered valid; for this, every new version of the control block may comprise a version number which is incremented in comparison to previously used ones, such that the control block written last can be identified by inspecting version numbers of the control blocks in the control area. Only after all segments in the control area 42 have been written, the first segment will be used again by way of address wraparound, so that a nearly equal number of rewrite cycles is ensured in this area, too. Of course, with version numbers stored in a fixed wordlength data field, they, too, will wrap-around at some instance, when the control blocks are updated often enough. But, because of the described nature of control blocks, consecutive control block writes will always be strictly cyclic within the control block area. Hence for recognizing the valid control block it suffices to ensure that version numbers are used from a value range which is either bigger than or no prime factor of the number of control blocks that the control block area can hold. The valid control block can then be recognized in that it is the only one, where the subsequent control block modulo within the control area does not bear the subsequent version number modulo within the version number value range.

A control block 53 may span more than one contiguous segments. Advantageously, control blocks are stored segment aligned, i.e. every control block starts at the beginning of the segment following the last segment of the previous control block. This implies that there may be unused space in the end part of the last segment of the previous control block, and this will be left unused. Segment alignment eases the identification of the last written and therefore currently valid control block. If the remaining segments of the control area 42 are not sufficient to store the complete new control block, then the control block uses these remaining segments and continues at the beginning of the control area, i.e. the control block may wrap around the control area borders.

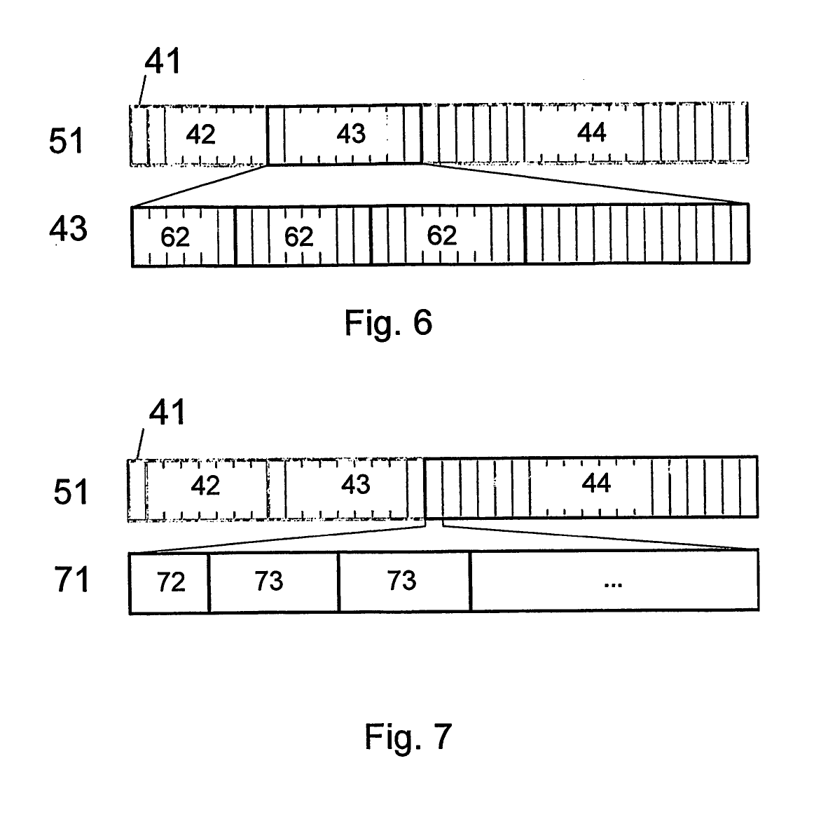

FIG. 6 illustrates an index area 43 which can store data of indexes 62. The format of the indexes is application specific and can be determined by a corresponding index type field in the control block 53. To prevent fragmentation under the limited rewrite cycle constraint, indexes 62 cannot be modified directly on the data carrier, since the changed index parts could not be overwritten. Therefore each index advantageously should occupy exactly one sequence of consecutive segments. Applications advantageously should read and write only entire indexes, they may hold the complete index in memory.

FIG. 7 illustrates a payload area 44 which typically occupies the largest part of the database file. All segments in this area, called payload segments 71, may have the same format. Each payload segment, if used, may contain a header 72 and one or more documents 73 or even only a part of a document.

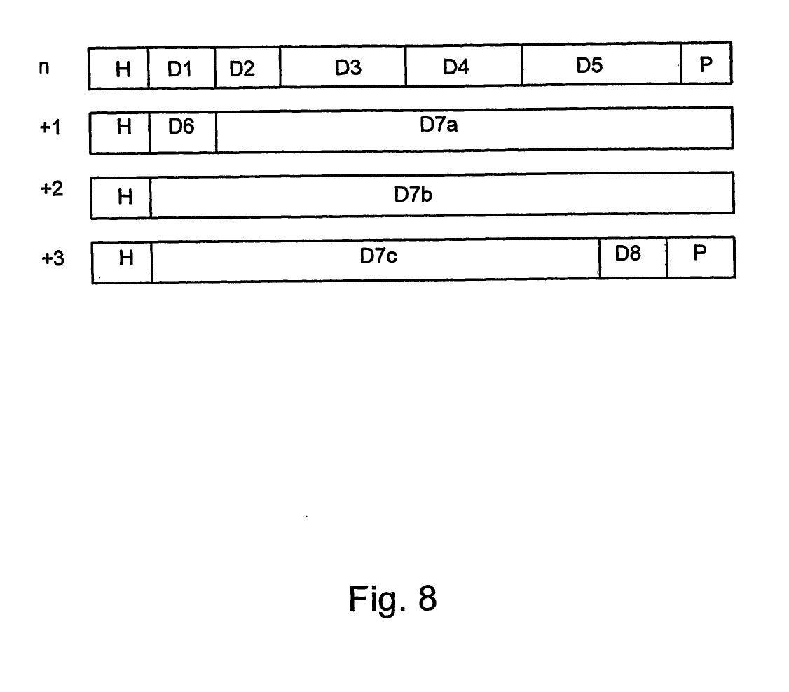

FIG. 8 illustrates a document write strategy according to the invention. Here, conceptually, each new document D1 . . . D8 is stored in a payload segment directly behind the previous document, as shown for documents D1 to D5 in segment Sn of the example. If the free space in the current segment doesn't suffice for the next document, the segment gets filled with padding bytes and the document is written to the next segment Sn+1. If a document is bigger than one segment, like document D7 in FIG. 8, or if the document does not fit into the remaining space of a segment, the document may span over the border of contiguous segments, as in segments Sn+1 to Sn+3. The remaining space of a segment may be filled with padding bytes P instead of splitting a document. This reduces the number of split documents, which in turn eases garbage collection and increases the probability of short segment groups. But it also increases the amount of unused payload space also known as slack. The header data H of each payload segment may contain information about the documents in the segment, like start address or size.

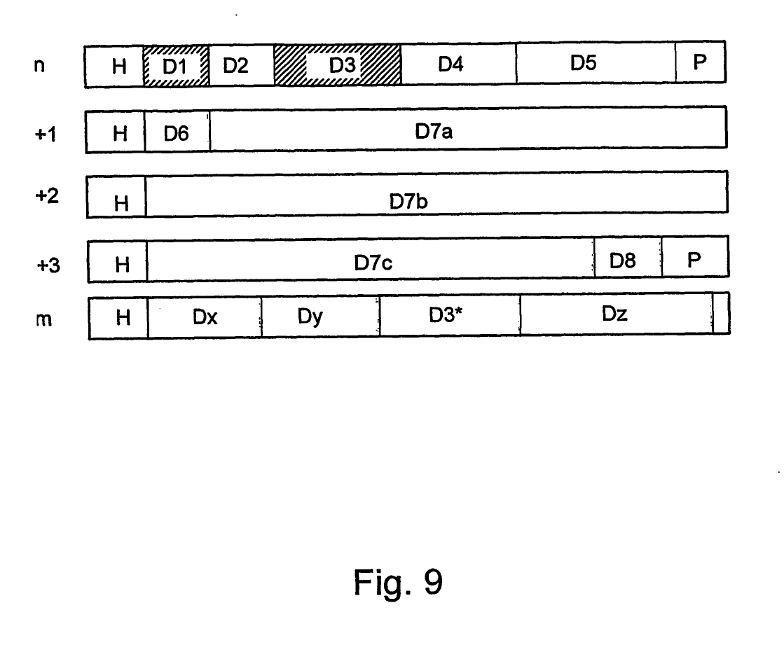

FIG. 9 illustrates a Document Edit and Delete Strategy. The rule that segments Sn . . . Sm can not be changed in-place but only be invalidated also affects documents. Starting from the same situation as FIG. 8, as shown in sector Sn, deleting document D1 and editing document D3 is shown. Document D1 is “deleted” by just invalidating its data in the payload segment it is stored in. This is done by a flag in the control block not shown, so that segment Sn itself needs not to be changed. To edit document D3, its original version has to be read into memory, modified in memory, and then stored like a new document into the next segment ready for writing, which in the example is segment Sm. The original document will then be invalidated as in the “delete” case.

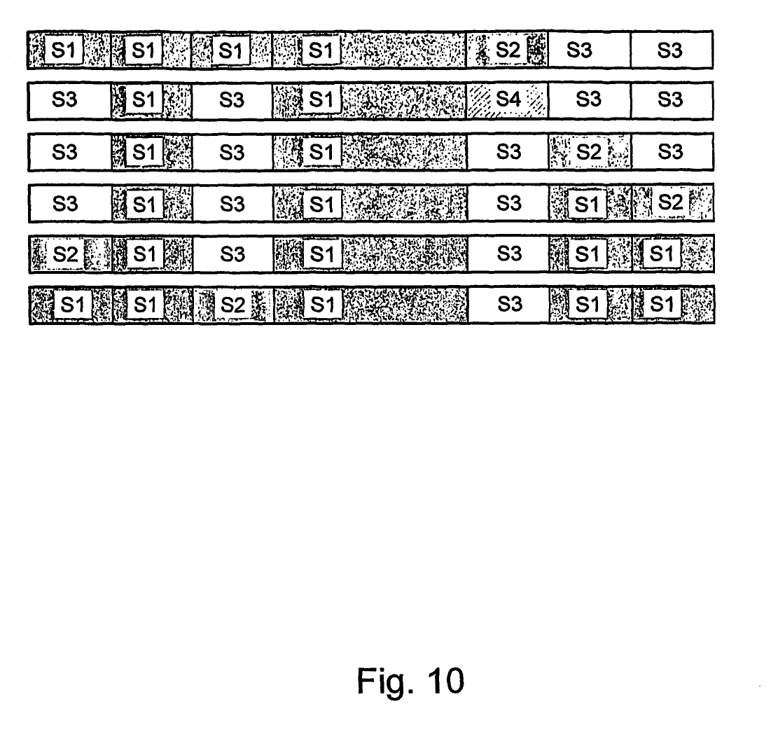

FIG. 10 illustrates a payload segment write strategy according to the invention. A complete payload area is shown in each “line” of the Figure at different, consecutive times t. The status of the segments is indicated as “used” S1, “last written and used” S2, “unused” S3, and “last written but already invalidated” S4. Basically, payload segments are being written to in a circular order according to their position in the payload area. The first line marked “t=t1” shows a database that has been continuously filled in this sense. Even if some of the previous segments happens to be invalidated, as shown at “t=t2”, the next segment data will nevertheless be written to the segment following the last written one S2, S4, as shown at “t=t3”. If the end of the payload area is reached, the write process wraps around and starts at the first unused segment of the area, as shown at “t=t5”. For subsequent write operations the next free segments will be used as shown at “t=t6”.

There is one exception where the next free segment should not be used: For storing documents that span segment borders, more than one consecutive segment may have to be used. In this case, a next free segment group not large enough for such storage has to be skipped until a usable group is found.

An alternative exists for the special case where documents, despite being smaller than a segment, happen to be stored such that they span segment borders. Such documents can be stored at the beginning of the next single free segment. The remaining free space of the current segment will then be left unused.

1. A method for modifying a database file (31) organized in segments (32) and stored on a storage medium (12) of limited rewritability, the method containing the steps of:
reserving, within the database file, at least one area (42, 43, 44) of predetermined size and position dedicated to writing thereto data records (D1 . . . D8) of at least one type, respectively;
and characterized by:
indicating within the database file, as a last written segment (S2) that segment within the area to which data records were last written;
ensuring distributed write in that, whenever a data record of a specific type is to be written to the database, the writing uses, within the area dedicated to the specific type, the next available segments after the last written segment.

2. The method of claim 1, used for modifying a data record (D1 . . . D8) of a specific type in the database file (31), wherein the database file contains an area dedicated to the specific type, and the method contains the steps of:
reading, from the area, the data record;
modifying the read data record;
obtaining a first write address information indicating a segment (S2) within the area to which a data record of the specific type was last written;
forwarding, as part of ensuring distributed write, the first write address information so that it indicates a next segment (S3) within the area which contains unused space;
writing the modified data record to segments starting at the segment as indicated by the first write address information.

3. The method of claim 2, wherein the data record is a payload data record (73), the specific type is a “payload” type, the area is a payload area (44), the database file additionally has a control area (42), and wherein the method additionally contains the steps of:
in case that an address information about the payload data record is contained in a control block (53) within the control area, reading, from the control area, the control block;
updating the address information in the control block to reflect the first write address;
obtaining a second write address information indicating the segment within the control area to which a control block was last written;
forwarding, as part of ensuring distributed write, the second write address information so that it indicates a next segment within the control area which contains unused space;
writing the updated control block to the segment as indicated by the second write address information.

4. The method of claim 1, used for deleting a payload data record (73) from the database file (31), wherein the database file contains a control area (42), and the method contains the steps of:
reading, from the control area, control blocks (53) containing information associated to the payload data record to be deleted;
marking, in the read control blocks, the payload data record to be deleted as deleted, thereby obtaining a modified control block;
obtaining a write address information indicating the segment within the control area to which a control block was last written;
forwarding, as part of ensuring distributed write, the write address information so that it indicates a next segment within the control area which contains unused space;
writing the modified control block to the segment as indicated by the forwarded write address information.

5. The method of any previous claim, wherein the step of ensuring distributed write contains substeps of
incrementing the write address information until it indicates a next segment after the last written segment (S2, S4) which contains unused space;
resetting the write address information to the start of the area in case the incrementing has caused the write address information to indicate a segment beyond the end of the area.

6. The method of any previous claim, wherein the size of the segments corresponds to an integer multiple of the size of sectors or ECC blocks as defined in a physical format on the storage medium (12).

7. The method of claim 6, wherein the segments are allocated on the storage medium to be sector or ECC block aligned.

8. The method of any previous claim, wherein the indicating is realized by attaching to a data record to be written a version count value which is incremented and taken modulo a predefined upper bound upon each writing, the version count getting written to the database file as part of the data record being written thereto.

9. The method of any previous claim, wherein the size of the at least one area (42,43,44) is chosen such that the average wear of the segments is equal.

10. A method for serving concurrent search operations (22 . . . 26) accessing a database file containing a number (z) of documents, the method containing the steps of:
incrementing, upon the launch of a new search operation to test a specific criterion on the documents in the database, an active search counter (27, 28);
launching (Start), in case the active search counter has a value indicating that one or more search operations are active and a document retrieve process (21) is not yet running, the document retrieve process which consecutively and cyclically retrieves (29) the documents contained in the database and provides them to any active search operations;
memorizing, in the launched new search operation receiving documents from the document retrieve process, as a first document an identifier of the document received first after launch, and applying the specific criterion on the received documents;
terminating, in case the search operation receives the first document a second time, the search operation and decrementing the active search counter;
terminating (End), in case the active search counter has a value indicating that no more search operations are active, the document retrieve process (21).

11. The method of claim 10, wherein the search operations originate from different sources.

12. A data carrier having stored thereon a database file (31) containing records (D1 . . . D8), characterized in that each record contains one distinct version number information monotonically related to the time when the record was written to the data carrier.

13. The data carrier of claim 12, additionally characterized in that only that record is predefined to be considered valid, for which the subsequent record does not bear the subsequent version number.
